(19) United States
(12) Patent Application Publication
(10) Pub. No.: US 2006/0139140 A1
(43) Pub. Date: Jun. 29, 2006

(54) AC-DC magnetic iron powder core, current wave filter coil

(76) Inventor: Kung-Hua Weng, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/020,100

(22) Filed: Dec. 27, 2004

(51) Int. Cl. H01F 27/30

(52) U.S. Cl. 336/208

(57) ABSTRACT

An improved AC-DC magnetic iron powder core, current wave filter coil that provides for winding a pair of coils using copper wire on magnetic iron core bobbins disposed in parallel as two members, with the two bobbins separated by a set distance, and an overlapping tie plate of one-piece construction integrating their two extremities. As such, the magnetic iron core increases the magnetic lines of force coverage field generated by the pair of coils, enabling an increase in magnetic induction rate (value), a decrease in magnetic leakage and the efficiency losses attributed to it, and lowering electrical system leakage of secondary magnetic emission interference to significantly enhance electrical utilization efficiency. Furthermore, the two bobbins are in a parallel arrangement and at a set distance apart that consistently defines a specific distance of separation between the two coils which optimizes electrical system utilization efficiency, quality, and safety, with the coils easily, conveniently, and rapidly implemented.

### BACKGROUND OF THE INVENTION

1) Field of the Invention

The invention herein relates to an improved AC-DC magnetic iron powder core, current wave filter coil.

2) Description of the Prior Art

Prior art AC-DC magnetic iron powder core, current wave filter coils are typically of the following types:

As indicated in FIG. 1, the magnetic iron core 1 is of one-piece construction in an annular shape with copper wire 201 respectively wound on two sides of the annular magnetic iron core 10 to form a pair of coils 20. In this arrangement, since the said magnetic iron core 10 is disposed as an annular shape, the said two windings are respectively wound on the two sides, but human error easily occurs during the winding process, resulting in a distance B between the endpoints of the two windings that is too small or even in contact and, as such, the safe range of distance B is not consistent and definite such that the quality of the current filter coil constructed has the drawbacks of instability and even potentially hazardous; of course, although the distance B between the endpoints of the said two windings slows winding speed and strengthens quality inspection to achieve control over the safe range, the consequent drawbacks directly affect production efficiency and also increase production cost, Furthermore, since the objective of the said magnetic iron core 10 of an annular shape is to utilize a simple structure to directly situate a pair of coils 20 at the two sides, the magnetic lines of force produced by the windings on such a structure cannot provide for a full coverage field, and the magnetic induction rate (value) is lower and magnetic leakage is greater; as such, the said resulting copper losses (copper conductive efficiency losses) and iron losses (magnetic iron efficiency losses) are increased, substantially detracting from efficiency quality requirements. Additionally, since such magnetic iron core 10 structures produce magnetic lines of force that cannot provide for a full coverage field at the coils, resulting in magnetic leakage of sizable proportions, the electrical system in which they are utilized are subject to secondary magnetic emission interference (interference emitted by the secondary lines of magnetic force), resulting in a large reduction in noise suppression efficiency.

As indicated in FIG. 2, the one-piece construction annular magnetic iron core shown in FIG. 1 divided into two half-moon shaped magnetic iron cores 10 and 10′, the said two half-moon shaped magnetic iron cores 10 and 10′ respectively provide for winding the copper wire 201 and 201′, following which the corresponding two ends are conjoined by an adhesive agent to assemble a current filter coil similar to that of the structure in FIG. 1. In this arrangement, although the winding of the copper wire 201 and 201′ is faster than that shown in FIG. 1, after the two half-moon shaped magnetic iron cores 10 and 10′ are assembled into an annular current filter coil, its production characteristics are totally identical with said drawbacks, especially at the area K of the said assembly, where the assembly gap fosters magnetic leakage to the extent that there is a substantial increase in magnetic leakage that becomes a drawback.

As indicated in FIG. 3 and FIG. 4, the magnetic iron core 10 is of one-piece construction in a bipartite rectangular shape and has a bobbin 101 disposed horizontally across the center that provides for winding two coils 20 of copper wire 201 on it, with the said two coils 20 separated by a distance B. In such structures, although a space A at the upper and lower extent of the current filter coil on the bobbin 101 provides for more magnetic lines of force in the coverage field, it is quite obvious that the said upper and lower spaces A do not completely encompass the two sides of the bobbin 101, resulting in the production of magnetic lines of force from the windings on the coil 20 such that there is still magnetic leakage from the two sides, causing the same drawback attributed to the said magnetic leakage; additionally, since the said pair of coils 20 are disposed on the same bobbin 101, winding the copper wire 201 such that the safety range of the two coils 20 is accurate and definite is impossible to control.

As indicated in FIG. 5, the one-piece construction bipartite rectangular magnetic iron core 10 shown in FIG. 3 and FIG. 4 is divided into two E-shaped magnetic iron cores 10 and 10′, the said two E-shaped magnetic iron cores 10 and 10′ respectively provide for winding the copper wire 201 and 201′, following which the corresponding endpoints are conjoined by an adhesive agent to assemble a current filter coil similar to that of the structure in FIG. 3 and FIG. 4. In this arrangement, although winding the copper wire 201 and 201′ on the embodiments in FIG. 3 and FIG. 4 is faster, the drawbacks of utilization are entirely identical, especially the direct increase in magnetic leakage produced at the assembly gap of area K.

As indicated in FIG. 6, the magnetic iron core 10 is of one-piece construction in a square shape and the said pair of coils 20 are disposed on the same bobbin 101 and separated by a distance B. Actually, as previously stated, since the magnetic iron core 10 of such structures are incapable of providing for a larger coverage field by the magnetic lines of force produced by the pair of coils 20, the magnetic leakage drawback of the current filter coil so formed is accordingly evident and, in terms of production, the resulting drawback is that the safety range between the said two coils 20 is likewise impossible to precisely control

### SUMMARY OF THE INVENTION

The primary objective of the invention herein is to provide an improved AC-DC magnetic iron powder core, current wave filter coil, wherein a pair of coils is wound on magnetic iron core bobbins disposed in parallel as two members, with the two bobbins separated by a set distance, thereby defining a specific distance of the safety range between the said pair of coils which not only affords further utilization safety, but at the same time enables the easier, convenient, and rapid winding of the copper wire.

Another objective of the invention herein is to provide an improved AC-DC magnetic iron powder core, current wave filter coil, wherein the two extremities of the said two bobbins disposed in parallel and at a set distance apart are integrated with a one-piece construction overlapping tie plate and, as such, the magnetic iron core effectively increases the magnetic lines of force coverage field generated by the pair of coils which not only achieves an increase in the magnetic induction rate (value) but, at the same time, minimizes magnetic leakage and lowers copper losses and iron losses such that the current filter coil has optimal efficiency quality, and electrical system secondary magnetic emission interference is effectively improved.

Still another objective of the invention herein is to provide an improved AC-DC magnetic iron powder core, current wave filter coil that is very straightforward in structure as well as simple and convenient to manufacture in which the current filter coil magnetic induction rate (value) is increased, magnetic leakage and efficiency losses produced by the current filter coil is minimized, electrical system electrical system secondary magnetic emission interference is significantly lowered, and the two coils of the current filter coil are consistently disposed at the safety range distance such that electrical system utilization efficiency and quality is greatly enhanced by the improved AC-DC magnetic iron powder core, current wave filter coil herein that is practical, ideal, and progressive and, furthermore, unprecedented.

### BRIEF DESCRIPTION OF THE DRAWINGS

FIG. 1 is an orthographic drawing of the prior art AC-DC magnetic iron power core, current wave coil (1).

FIG. 2 is an orthographic drawing of the prior art AC-DC magnetic iron power core, current wave coil (2).

FIG. 3 is an orthographic drawing of the prior art AC-DC magnetic iron power core, current wave coil (3).

FIG. 4 is a cross-sectional drawing of FIG. 3.

FIG. 5 is an orthographic drawing of the prior art AC-DC magnetic iron power core, current wave coil (4).

FIG. 6 is an orthographic drawing of the prior art AC-DC magnetic iron power core, current wave coil (5).

FIG. 7 is an isometric drawing of the invention herein.

FIG. 8 is an orthographic drawing of FIG. 7.

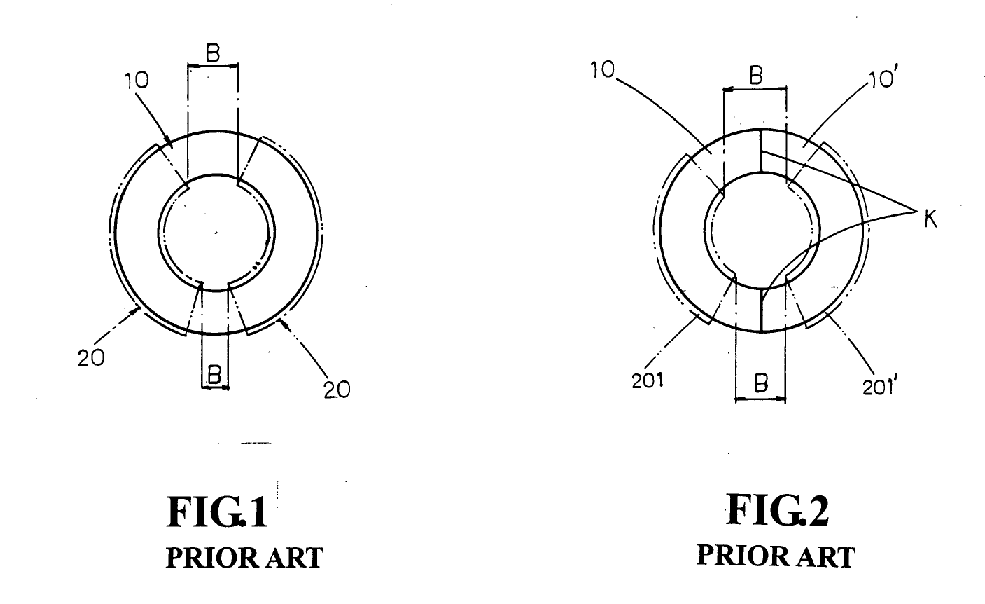

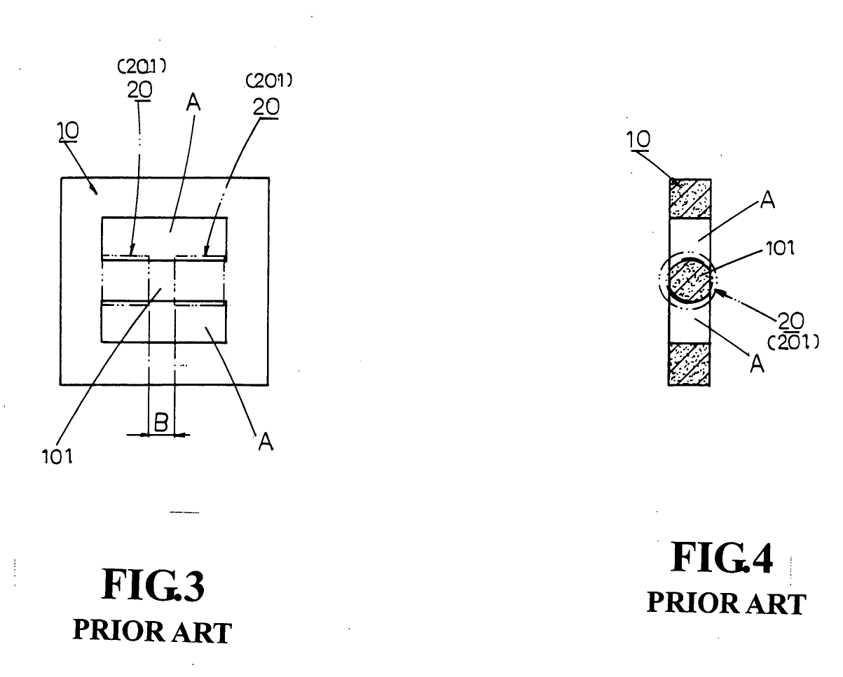

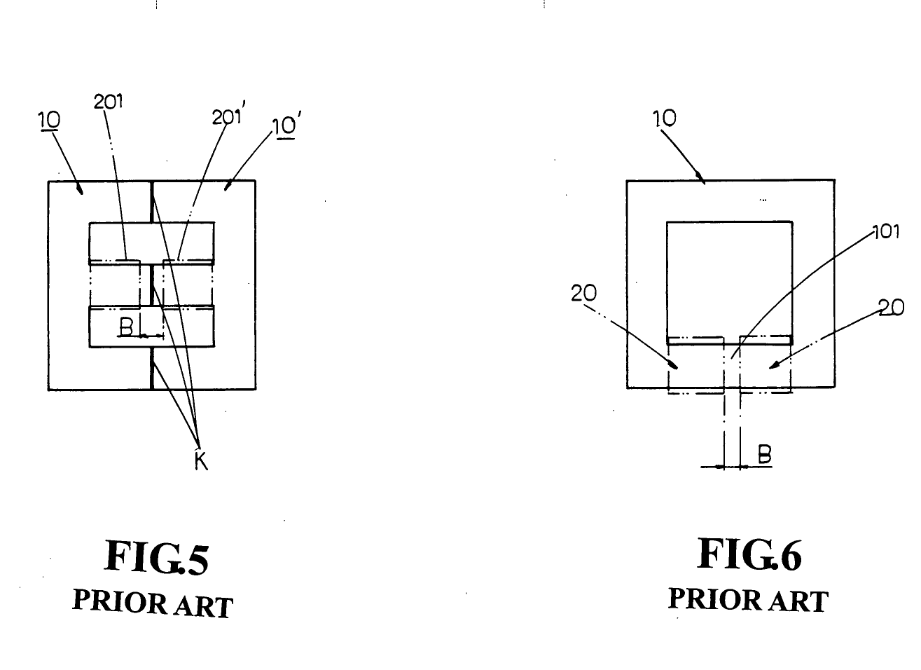

### DETAILED DESCRIPTION OF THE PREFERRED EMBODIMENTS

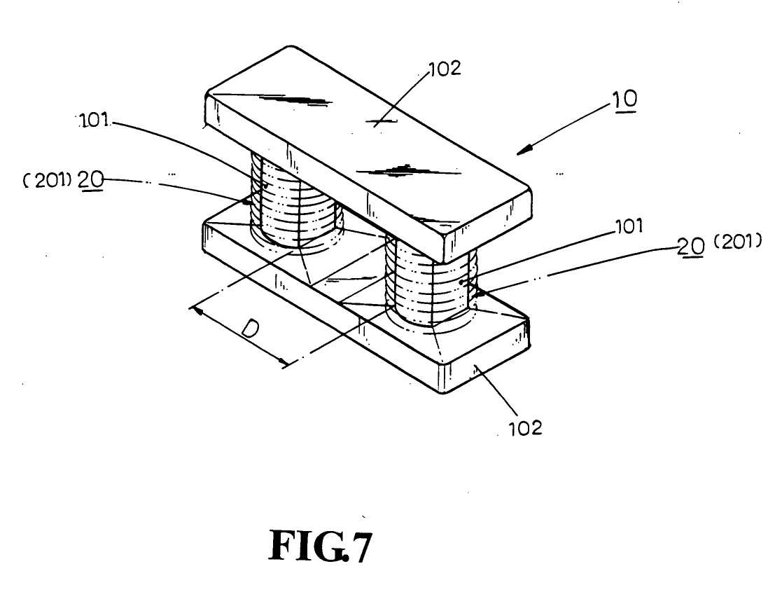

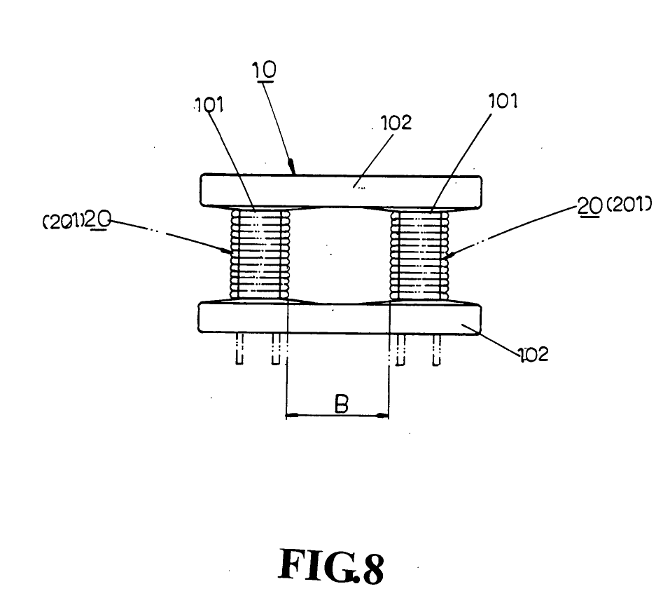

Referring to FIG. 7 and FIG. 8, the improved AC-DC magnetic iron powder core, current wave filter coil of the invention herein is comprised of a magnetic iron core 10 bobbin 101 that provides for winding copper wire 201 to form a pair of coils 20 in parallel on two members, with the said two parallel bobbins 101 separated by a set distance D, and an overlapping tie plate 102 of one-piece construction integrating their two extremities.

The two extremities of the said two bobbins 101 and the fixing plate 102 have a slanted planar coupling means disposed between them to increase conjoinment integrity.

Utilizing the said structure of the invention herein, since the said two bobbins 101 are disposed at the set distance D and in parallel, after the copper wire 201 is respectively wound on them to form the pair of coils 20, the said pair of coils 20 are separated by a specific distance B, the said specific distance B determining the safe range between a conventional pair of coils and, obviously, since the distance between the said conventional pair of coils is difficult to accurately control, hazards readily occur or copper wire winding is troublesome, inconvenient, slow, and other drawbacks for which substantial and, furthermore, effective improvement is attainable.

In other words, the said two bobbins 101 are in a parallel arrangement and separated by the set distance D, and after the copper wire 201 is respectively wound to form the pair of coils 20, the parallel arrangement does not result in an excessively narrow interval between their two extremities or mutual contact and, as such, the distance D separating the said two bobbins 101 is easily determined and given that the distance B between the pair of coils 20 is within the safe range, the said coils 20 are not only easily, conveniently, and rapidly wound to meet production requirements, but also provide for greater utilization safety during.

Furthermore, since the two extremities of the said two bobbins 101 are respectively integrated with the one-piece construction overlapping tie plate 102 and are capable of directly increasing the magnetic lines of force coverage field generated by the pair of coils 20, the magnetic induction rate (value) produced by the said pair of coils 20 is proportionately raised and the resultant magnetic leakage is minimized, thereby reducing copper losses, increasing iron loss efficiency, and significantly lowering secondary magnetic emission interference and, as such, the electrical efficiency of the improved AC-DC magnetic iron powder core current wave coil of the invention herein is substantially enhanced and, furthermore, effectively improves upon the drawbacks of the conventional coil which is incapable of producing magnetic lines of force at full coverage.

1. An AC-DC magnetic iron powder core for a current wave filter coil, comprising:
a pair of magnetic iron core bobbins for supporting a pair of coils, said magnetic iron core bobbins being disposed in parallel and separated by a set distance, each of said magnetic iron core bobbing having first and second extremities; and,
a pair of overlapping tie plates of one-piece construction spaced one from the other by said magnetic iron core bobbins, one of said overlapping tie plates being connected to extend continuously between said first extremities of said magnetic iron core bobbins, the other of said overlapping tie plates being connected to extend continuously between said second extremities.

2. The AC-DC magnetic iron powder core for a current wave filter coil as recited in claim 1, wherein said bobbins are separated by sufficient distance to provide clearance for said pair of coils wound thereon to remain spaced by a distance within a preset safe range.

3. An AC-DC magnetic iron powder core for a current wave filter coil comprising:
a pair of spaced tie plates each having one-piece construction; and,
a pair of magnetic iron core bobbins for the winding of respective coils thereabout, said magnetic iron core bobbins being connected to said pair of tie plates to extend transversely between spaced intermediate portions thereof, said pair of magnetic iron core bobbins being disposed substantially in parallel and separated by a set distance one from the other;
whereby each said tie plates extends continuously between respective ends of said magnetic iron core bobbins.
